(19) United States
(12) Patent Application Publication
(10) Pub. No.: US 2014/0183251 A1
(43) Pub. Date: Jul. 3, 2014

(54) ENVELOPE HAVING INTEGRATED AND REMOVABLE LABEL AND PROCESS FOR MANUFACTURING SAME

(71) Applicant: Ennis, Inc., Midlothian, TX (US)

(72) Inventors: Richard Miller, Galena, KS (US); William Elmore, Columbus, KS (US)

(73) Assignee: Ennis, Inc., Midlothian, TX (US)

(21) Appl. No.: 14/201,400

(22) Filed: Mar. 7, 2014

Related U.S. Application Data
(63) Continuation-in-part of application No. 12/764,458, filed on Apr. 21, 2010.

(51) Int. Cl. B65D 27/12; B31B 19/14

(52) U.S. Cl. CPC B65D 27/12; B31B 19/14
USPC 229/76; 493/227

(57) ABSTRACT

An envelope design and processes for manufacturing said envelopes is disclosed herein. The disclosed envelopes have an integrated and removable label portion secured within a panel of the envelope by an adhesive liner. The envelopes may be manufactured by die-cutting the label portions in a paper web, applying the adhesive liner to one side of the paper web covering the die-cut label portions, die-cutting an envelope blank from the paper web, and forming a folded envelope from the blank.

### CROSS-REFERENCE TO RELATED APPLICATIONS

This patent application is a continuation-in-part patent application of U.S. patent application Ser. No. 12/764,458 that was filed on Apr. 21, 2010.

### TECHNICAL FIELD OF THE INVENTION

The present disclosure is directed to envelopes and processes for manufacturing envelopes.

### STATEMENT OF FEDERALLY FUNDED RESEARCH

None.

### BACKGROUND OF THE INVENTION

Without limiting the scope of the invention, this invention relates generally to the field of envelopes and manufacturing processes for envelopes.

U.S. Pat. No. 5,002,220 (Safranski, 1991) discloses an envelope closure having a flap with a detachable tab. Adhesive transfer tape is applied to the flap and tab, thus enabling adhesive and a protective liner to be applied in a single step. The tab may be separated from the flap, providing a convenient handhold for removing the protective liner.

U.S. Pat. No. 5,429,576 (Doderer-winkler, 1995) describes a reusable adhesive envelope and a method and apparatus for making same. The envelope includes a pouch adapted to receive the contents and having an open edge. A flap is mounted adjacent to this open edge and may be folded about a flap fold to close the pouch opening. The exterior of the pouch mounts a protective strip. The interior face of the flap mounts a pressure sensitive adhesive, which is initially covered by a release liner. Upon removing the release liner the adhesive on the flap may be secure to the protective strip to close the flap. The flap may be opened and reclosed numerous times. The protective strip and the adhesive/release liner combination are each applied to the envelope as tape strips. With the envelopes in the open configuration these tape strips are alternately applied from a single transfer mechanism.

U.S. Pat. No. 7,213,844 (Malette and Duhaime, 2007) discloses an envelope with integrated tracking labels for forwarding on important documents where proof of delivery and reception is required is described herein. The envelope has a securing flap which is provided with a receipt tear panel formed in a free end section of the flap and provided with a tracking number printed thereon. A glue strip extends longitudinally across an inner face of the securing flap. A release liner is removably retained over the glue strip. A tracking label having the same tracking number is die-cut in the securing flap over the release liner. The release liner is scored to form a tracking label release liner section adhered to the glue strip about the tracking label whereby to retain the tracking label in the securing flap. The glue strip secures the securing flap to an edge section of the other panel when folded thereon on the fold line. The tracking number is also printed on one of the panels. The tracking label is removed from the tracking label release liner of the securing flap as proof of sending or reception of the envelope.

### SUMMARY OF THE INVENTION

Various embodiments disclosed herein are directed to an envelope comprising a face panel, a back panel connected to the face panel, and a closure panel. The closure panel may be configured to be secured to the back panel. Each panel may comprise an outwardly facing surface and an inwardly facing surface. At least one of the face panel, the back panel, and the closure panel may comprise an open portion extending through the panel from the outwardly facing surface to the inwardly facing surface. The envelope may also comprise a liner attached with an adhesive to the inwardly facing surface of the panel comprising the open portion. The liner may comprise a backing and a film of the adhesive continuously covering a side of the backing. The liner may be positioned on the inwardly facing surface to cover the open portion. The envelope may also comprise a label portion positioned within the open portion and removably secured to the liner with the adhesive. The label portion may be integrated with the panel. The label portion may be separable from the envelope to form a separate label.

In use, when the label portion is removed from the open portion and separated from the liner and the envelope, the adhesive substantially covers the inwardly facing surface of the label portion. In this manner, the integrated label portion may be separated and removed from the envelope, thereby forming a separate label that may then be attached to a separate surface using a continuous adhesive film on the back of the label. In use, when the label portion is separated and removed, the liner stays secured to the inwardly facing surface of the face panel, thereby maintaining the integrity of the face panel of the envelope. The portion of the liner exposed through the open portion in the face panel of the envelope when the label portion is removed may be substantially free of adhesive, which has been substantially transferred to the inwardly facing surface of the label portion.

Other embodiments disclosed herein are directed to processes for manufacturing envelopes. The processes may comprise feeding a continuous paper web to label-forming equipment. In the label-forming equipment, a plurality of label portions may be die-cut into the paper web. A plurality of adhesive liners may be applied to one side of the paper web in the label-forming equipment. The adhesive liners may cover the die-cut label portions and secure the die-cut label portions in the paper web. The paper web may be fed into die-cutting equipment. In the die-cutting equipment, a plurality of envelope blanks may be die-cut from the paper web. Each die-cut envelope blank may comprise at least one die-cut label portion secured in the envelope blank by the adhesive liner. The die-cut envelope blanks may be fed into envelope-forming equipment. In the envelope-forming equipment, adhesive may be applied to the envelope blanks The envelope blanks may be folded into formed envelopes. The formed envelopes may comprise at least one die-cut label portion secured in each envelope by the adhesive liner. The label portion may be integrated with the envelope and separable from the envelope to form a separate label.

In one embodiment, the present invention includes an envelope comprising: a face panel, a back panel connected to the face panel, and a closure panel connected to the face panel and configured to be secured to the back panel, wherein each panel comprises an outwardly facing surface and an inwardly facing surface, wherein at least one of the face panel, the back panel, and the closure panel comprises an open portion having dimensions commensurate with a label portion, wherein the open portion extends through the panel from the outwardly facing surface to the inwardly facing surface; a liner comprising a backing sheet and a continuous film of a pressure sensitive adhesive applied to a side of the backing sheet, the liner attached with the adhesive to the inwardly facing surface of the at least one panel comprising the open portion, wherein the adhesive of the liner covers the open portion on the inwardly facing surface of the panel; and a label portion positioned within the open portion and removably secured to the liner with the adhesive, wherein the label portion is integrated with the panel comprising the open portion, wherein the label portion is separable from the envelope without tearing any portion of the envelope or any portion of the label portion, and wherein the label portion is separable from the envelope without applying a release agent. In one aspect, the continuous film of the pressure sensitive adhesive applied to the backing sheet comprises a removable adhesive that substantially transfers from the backing sheet to the label portion so that the label portion comprises a substantially continuous film of pressure sensitive adhesive when the label portion is separated from the envelope, thereby forming a separate adhesive label. In another aspect, the face panel, the back panel, the closure panel, and the label portion all comprise paper die-cut from a common paper web. In another aspect, the envelope further comprises a window extending through the face panel. In another aspect, the envelope further comprises a substantially transparent window patch adhered to the inwardly facing surface of the face panel, the window patch positioned on the inwardly facing surface of the face panel covering the window. In another aspect, the label portion comprises indicia printed into an outwardly facing surface of the label portion.

In another embodiment, the present invention includes a process for manufacturing an envelope comprising: feeding a continuous paper web to label-forming equipment; die-cutting a plurality of label portions in the paper web; applying a plurality of adhesive liners to one side of the paper web, wherein the adhesive liners cover the die-cut label portions and secure the die-cut label portions in the paper web; feeding the paper web to die-cutting equipment; die-cutting a plurality of envelope blanks from the paper web, wherein each die-cut envelope blank comprises at least one die-cut label portion secured in the envelope blank by the adhesive liner; feeding the die-cut envelope blanks to an envelope-forming equipment; applying an adhesive to the envelope blanks; and folding the envelope blanks into formed envelopes comprising at least one die-cut label portion secured in each envelope by the adhesive liner, wherein the label portion is integrated with the envelope and separable from the envelope to form a separate adhesive label, wherein the label portion is separable from the envelope without applying a release agent. In one aspect, the label-forming equipment comprises a Tamarack® machine. In another aspect, the envelope-forming equipment comprises a W+D folding machine or a F.L. Smithe folding machine. In another aspect, the envelope further comprises die-cutting a window through a face panel of the envelope blank. In another aspect, the process further comprises applying a transparent window patch over the die-cut window. In another aspect, the process further comprises applying printing indicia into an outwardly facing surface of the adhesive label.

In another embodiment, the present invention includes system for manufacturing an envelope comprising: a Tamarack® machine or a suitable label-forming equipment, wherein the label-forming equipment die-cuts a plurality of label portions on a fed continuous paper web followed by application of a plurality of adhesive liners to one side of the paper web covering the die-cut label portions and secure the die-cut label portions in the paper web; a die-cutting equipment for die-cutting a plurality of envelope blanks from the paper web, wherein each die-cut envelope blank comprises at least one die-cut label portion secured in the envelope blank by the adhesive liner; an equipment for die-cutting a window through a face panel of the envelope blank; an equipment for applying a transparent window patch over the die-cut window; a W+D folding machine, a F.L. Smithe folding machine or a similar envelope-forming equipment, wherein the equipment applies an adhesive to the envelope blanks and folds the envelope blanks into formed envelopes comprising at least one die-cut label portion secured in each envelope by the adhesive liner, wherein the label portion is integrated with the envelope and separable from the envelope to form a separate adhesive label, wherein the label portion is separable from the envelope without applying a release agent; and a printing equipment for printing optional indicia into an outwardly facing surface of the adhesive label.

It is understood that the invention is not limited to the embodiments disclosed in this summary. It is intended that the invention encompass modifications that are within the scope of the claims.

### BRIEF DESCRIPTION OF THE DRAWINGS

For a more complete understanding of the features and advantages of the present invention, reference is now made to the detailed description of the invention along with the accompanying figures and in which:

FIGS. 1A-1D depict one embodiment of an unfolded envelope blank having a removable label portion integrated in the face panel of the envelope and secured by a liner, wherein FIG. 1A is a front view of outwardly facing surfaces of the envelope blank, FIG. 1B is a rear view of inwardly facing surfaces of the envelope blank, and FIGS. 1C and 1D are partial sectional views of the face panel of the envelope showing the label portion, the liner, and a layer of adhesive covering the outwardly facing surface of the liner;

FIGS. 2A and 2B depict one embodiment of an unfolded look-in style envelope blank having a removable label portion integrated in the face panel of the envelope and secured by a liner, the face panel having a cut-out window there through, wherein FIG. 2A is a front view of outwardly facing surfaces of the envelope blank, and FIG. 2B is a rear view of inwardly facing surfaces of the envelope blank;

FIGS. 3A-3D depict one embodiment of an envelope formed from the envelope blank depicted in FIGS. 1A-D, the envelope having a removable label portion integrated in the face panel of the envelope, wherein FIG. 3A is a front view of the envelope in an open position, FIG. 3B is a rear view of the envelope in an open position, FIG. 3C is an alternative rear view of the envelop in an open position, and FIG. 3D is a rear view of the envelope in a closed position;

FIGS. 4A and 4B illustrate a partially exploded perspective view of a closed envelope depicting a label portion being positioned on and removed from the envelope. FIG. 4A depicts a label portion being positioned in the open portion and attached to the outwardly facing surface of the liner. FIG. 4B depicts a label portion being removed from the outwardly facing surface of the face panel revealing an open portion through the face panel which is covered by a liner attached to the inwardly facing surface of the face panel; and

FIG. 5 is a flow diagram illustrating one embodiment of a process for manufacturing envelopes having integrated and removable label portions.

### DETAILED DESCRIPTION OF THE INVENTION

While the making and using of various embodiments of the present invention are discussed in detail below, it should be appreciated that the present invention provides many applicable inventive concepts that can be embodied in a wide variety of specific contexts. The specific embodiments discussed herein are merely illustrative of specific ways to make and use the invention and do not delimit the scope of the invention.

To facilitate the understanding of this invention, a number of terms are defined below. Terms defined herein have meanings as commonly understood by a person of ordinary skill in the areas relevant to the present invention. Terms such as “a”, “an” and “the” are not intended to refer to only a singular entity, but include the general class of which a specific example may be used for illustration. The terminology herein is used to describe specific embodiments of the invention, but their usage does not delimit the invention, except as outlined in the claims.

The term “envelopes” refers to any paper or even cardboard bags designed to receive letters, sheets of paper, or any other article that might be contained therein. In general, an envelope is considered to be a “flat item”, a term that is in frequent use.

The terms “adhesive” and “pressure sensitive adhesive” as used herein include all adhesives which are conventionally used to apply labels, tapes, webs, sheets, or other materials to surfaces by means of applied pressure. Typical adhesives of concern are water soluble and solvent-soluble systems, often but not exclusively based on acrylics, latexes, or synthetic rubbers.

The term “paper web” as used herein includes any web containing cellulosic fibers alone or in combination with other fibers, natural or synthetic, wherein the sheet is generally intended for a single use, after which, it is discarded.

The term “label” as used herein includes bands, strips and other wrappers capable of being adhesively secured to an article. The term “die cut” as used herein is intended to include any method of rapid cutting of sheet material which lends itself to automated production. The term “indicia” is broadly defined herein to include anything that provides a visible indication in one or more types of light.

The present invention discloses an envelope design, wherein the envelopes have an integrated and removable label portion secured within a panel of the envelope by an adhesive liner. The envelopes may be manufactured by die-cutting the label portions in a paper web, applying the adhesive liner to one side of the paper web covering the die-cut label portions, die-cutting an envelope blank from the paper web, and forming a folded envelope from the blank. Further, the present invention also describes a manufacturing process for the envelope described herein.

Envelopes may be used to protect, transport and/or store various contents, such as, for example, documents, correspondence, and the like. Envelopes comprise a large number of configurations in terms of shape, size, material of construction, functional layout and indicia, for example. However, existing envelopes may be limited in terms of functionality beyond the mere protection, storage, and transportation of items contained within the envelopes. For example, generally, markings or other indicia on the outwardly facing surfaces of envelopes are permanently associated with the envelopes because the markings or indicia are printed directly onto or otherwise permanently fixed to the external surfaces of the envelopes.

The embodiments disclosed herein are directed to envelopes comprising a face panel, a back panel connected to the face panel, and a closure panel. The closure panel may be configured to be secured to the back panel. Each panel may comprise an outwardly facing surface and an inwardly facing surface. At least one of the face panel, the back panel, and the closure panel may comprise an open portion extending through the panel from the outwardly facing surface to the inwardly facing surface. The envelopes may also comprise a liner attached with an adhesive to the inwardly facing surface of the panel comprising the open portion. The liner may comprise a backing and a film of the adhesive continuously covering a side of the backing. The liner may be positioned on the inwardly facing surface to cover the open portion. The envelopes may also comprise a label portion positioned within the open portion and removably secured to the liner with the adhesive. The label portion may be integrated with the panel. The label portion may be separable from the envelope to form a separate label.

In various embodiments, the envelope may comprise a face panel and a back panel. The face panel may comprise a top edge, a bottom edge and two (2) side edges which surround a substantially rectangular face panel. Two (2) side flaps may extend from the side edges, and a bottom flap may extend from the bottom edge. The face panel may comprise an outwardly facing surface and an inwardly facing surface. The side flaps and the bottom flap may fold inwardly relative to the outwardly facing surface of the face panel and toward the inwardly facing surface of the face panel to form the back panel. The back panel may be connected to the face panel along the two (2) side edges and the bottom edge. A closure panel may extend from the top edge of the face panel, and may be foldable toward the back panel and securable to the back panel to form an enclosed space within the envelope.

In various embodiments, the face panel may comprise a label portion. The face panel, the label portion, the closure panel, and the back panel (e.g., the side flaps and the bottom flap) may all be die-cut from a common paper web. The label portion may be integrated with the face panel in an open portion formed by the die-cut. The label portion may comprise an outwardly facing surface and an inwardly facing surface. The outwardly facing surface of the label portion and the inwardly facing surface of the label portion may be substantially co-planar with the outwardly facing surface of the face panel and the inwardly facing surface of the face panel, respectively, when the label portion is positioned in the open portion formed by the die-cut. In this manner, for example, the label portion is integrated with the face panel of the envelope.

The label portion may be held in place in the open portion formed by the die-cut with an adhesive liner applied to the inwardly facing surface of the face panel and positioned over the open portion formed by the die-cut. The liner may comprise a backing sheet and an adhesive film continuously covering a side of the backing sheet. The side of the liner in contact with the inwardly facing surface of the face panel may comprise the side of backing sheet covered with the adhesive film. The area of the liner may be larger than the area of the open portion formed by the die-cut so that there is overlap between the liner and the portion of the inwardly facing surface of the face panel surrounding the die-cut. The liner may be attached to the inwardly facing surface of the face panel in the overlapping portion. The liner may also be removably attached to the inwardly facing surface of the label portion when the label portion is positioned in the open portion, thereby holding the label portion in position in the open portion through the face panel. In various embodiments, the outwardly facing surface of the label portion may comprise markings or other indicia.

The liner may comprise a backing sheet and a continuous film of pressure-sensitive removable adhesive applied to one side of the backing sheet. The backing sheet and the adhesive may be configured so that when the surface of the liner comprising the adhesive film is applied to the inwardly facing surfaces of the face panel and the label portion positioned in the open portion formed by the die-cut, the adhesive film transfers from the backing sheet to the paper comprising the face panel and the label portion. In this manner, the liner may function as a release sheet for the label portion.

In use, when the label portion is removed from the open portion die-cut in the face panel and is thereby separated from the liner and the envelope, the transferred adhesive film substantially covers the inwardly facing surface of the removed label portion. In this manner, the integrated label portion may be separated and removed from the envelope, thereby forming a separate label that may then be attached to a separate surface using the continuous adhesive film on the back of the label. The label portion is separable from the envelope without applying a release agent. In use, when the label portion is separated and removed, the liner stays secured to the inwardly facing surface of the face panel, thereby maintaining the integrity of the face panel of the envelope. The portion of the liner exposed through the open portion in the face panel of the envelope when the label portion is removed may be substantially free of adhesive, which has been substantially transferred to the inwardly facing surface of the label portion.

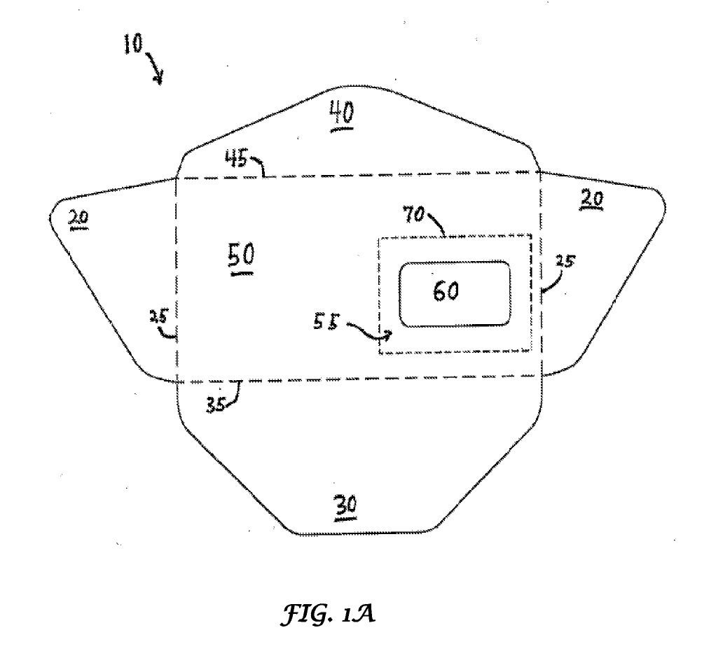

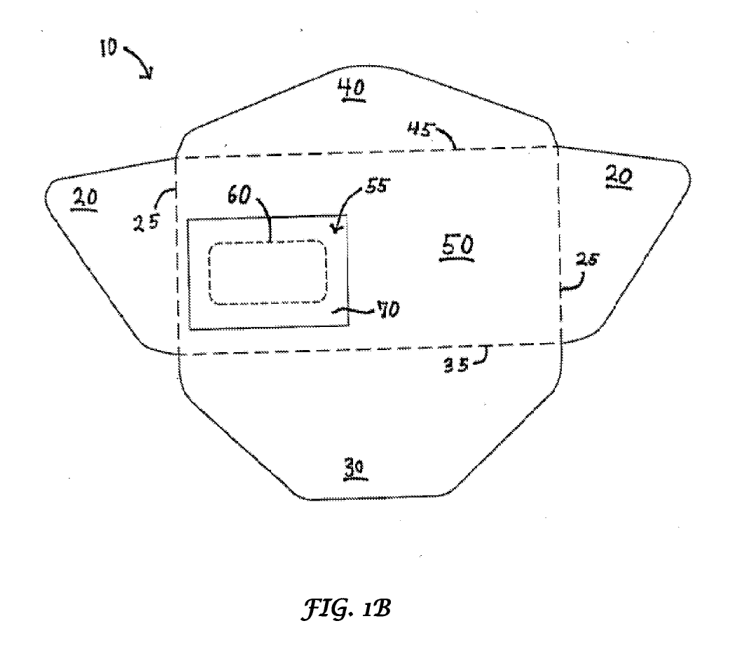

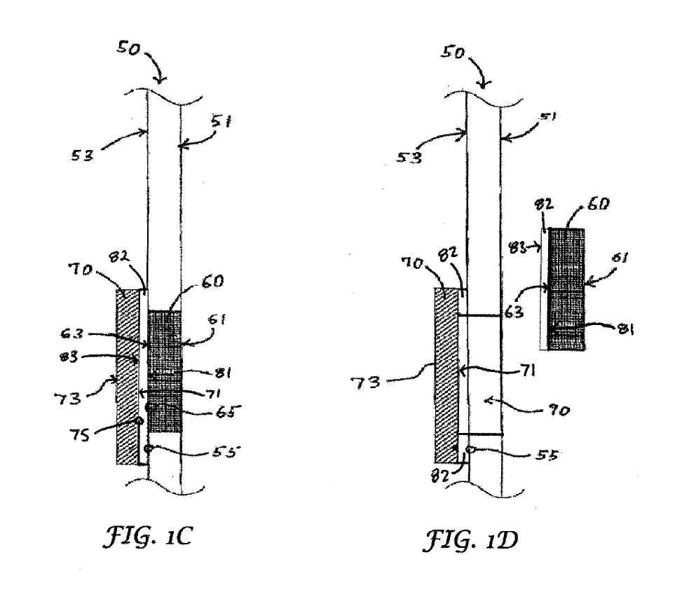

FIG. 1A illustrates a front view of an unfolded envelope blank 10. The unfolded envelope blank 10 comprises a face panel 50, side flaps 20, a bottom flap 30, and a closure panel 40. The face panel 50 comprises side edges 25, a bottom edge 35, and a top edge 45, which surround the substantially rectangular face panel 50. The side flaps 20 respectively extend from the side edges 25. The bottom flap 30 extends from the bottom edge 35. The closure panel 40 extends from the top edge 45.

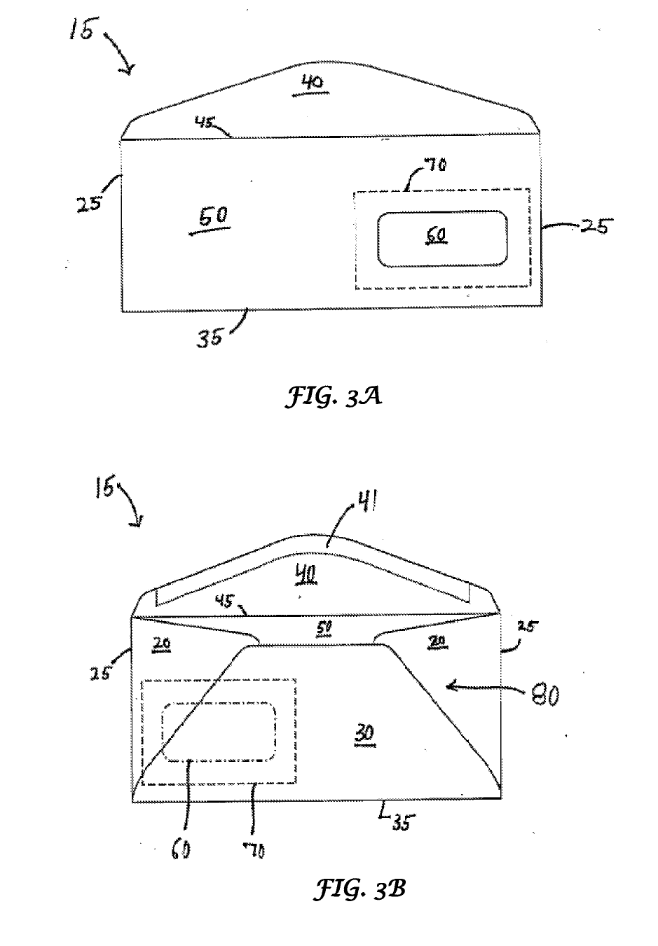

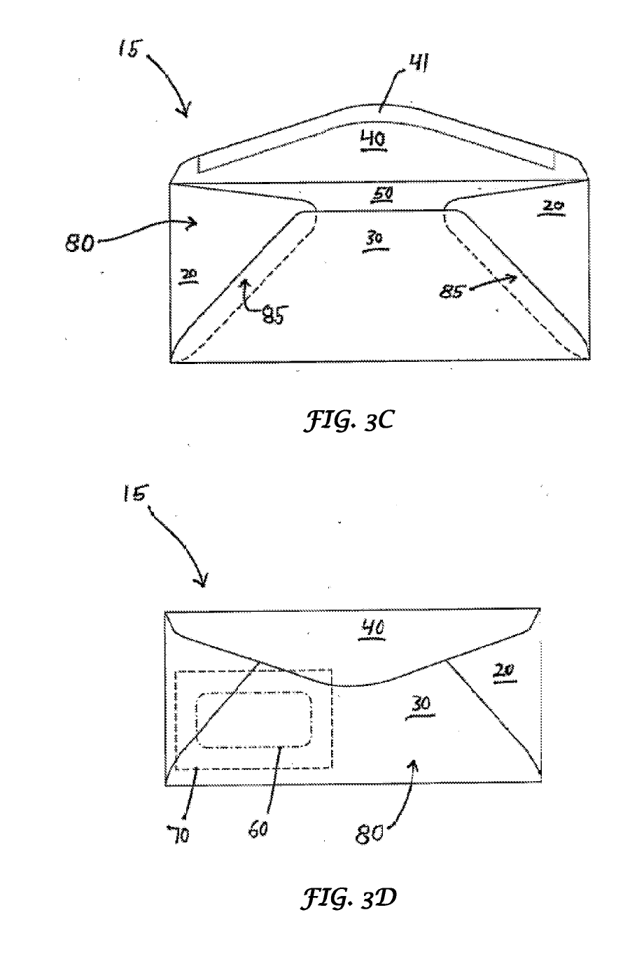

The envelope blank 10 is foldable along the side edges 25, the bottom edge 35, and the top edge 45. The side flaps 20 and the bottom flap 30 are configured to fold together to form a rear panel 80 (see FIGS. 3B, 3C and 3D). The rear panel 80 may be formed by securing together overlapping portions of the folded side flaps 20 and the folded bottom flap 30 to form side seams 85 (see FIG. 3C). The closure panel 40 is configured to fold onto the rear panel 80 and secure thereto, thereby forming an enclosed space within the envelope (see FIG. 3D). When the envelope blank 10 is folded and secured into a formed envelope, the surfaces illustrated in FIG. 1A correspond to outwardly facing surfaces of the envelope, and the surfaces illustrated in FIG. 1B (i.e., on the opposite side) correspond to inwardly facing surfaces of the envelope.

A removable label portion 60 is integrated in the face panel 50 of the envelope blank 10. The removable label portion 60 is positioned in an open portion 90 extending through the thickness of the face panel 50 from an outwardly facing surface 51 to an inwardly facing surface 53 (see FIG. 1D). The label portion 60 is removably secured to a liner 70 attached to the inwardly facing surface 53 of the face panel 50 at surface interface region 55. The liner 70 is shown in FIG. 1A in dashed-line form to indicate that the liner 70 is not directly visible when viewing the outwardly facing surfaces of the envelope blank 10.

FIG. 1B illustrates a rear view of the unfolded envelope blank 10 illustrated in FIG. 1A. The liner 70 is shown positioned over the label portion 60 and attached to the inwardly facing surface of the face panel 50. The label portion 60 is shown in FIG. 1B in dashed-line form to indicate that the label portion 60 is not directly visible when viewing the inwardly facing surfaces of the envelope blank 10.

FIGS. 1C and 1D illustrate partial sectional views of the face panel 50. In FIG. 1C, the label portion 60 is positioned in the open portion 90 (shown in FIG. 1D) extending through the face panel 50 from the outwardly facing surface 51 to the inwardly facing surface 53. In this manner, the label portion 60 is integrated with the face panel 50. The outwardly facing surface 61 of the label portion 60 and the outwardly facing surface 51 of the face panel 50 are substantially co-planar. The inwardly facing surface 63 of the label portion 60 and the inwardly facing surface 53 of the face panel 50 are also substantially co-planar. The liner 70 is shown positioned over the label portion 60 in FIG. 1C. The liner 70 is attached to the inwardly facing surface 53 of face panel 50 by an adhesive layer 82 continuously covering the outwardly facing surface 71 of the liner 70. In this manner, the inwardly facing surface 53 of face panel 50 adheres with the outwardly facing surface 81 of the adhesive layer 82 in the surface interface region 55. The inwardly facing surface 83 of adhesive layer 80 adheres with the outwardly facing surface 71 of the liner 70 in the surface interface region 75. The label portion 60 is held in position in the open portion 90 by the adhesive layer 82 continuously covering the outwardly facing surface 71 of the liner 70. In this manner, the inwardly facing surface 63 of the label portion 60 adheres with the outwardly facing surface 81 of the adhesive layer 82 in the surface interface region 65.

In FIG. 1D, the label portion 60 is removed from the face panel 50, revealing the open portion 90 extending through the face panel 50. The liner 70 is positioned over the open portion 90 through the face panel 50, and the outwardly facing surface 71 of the liner 70 is visible through the open portion 90. The outwardly facing surface 71 of the liner 70 is substantially free of adhesive layer 82 in the area formally adhered to the inwardly facing surface 63 of the label portion 60. The inwardly facing surface 63 of the label portion 60 is substantially continuously covered with a film of the adhesive layer 82. In this manner, separated label portion 60 comprises a separate label that may be secured to other surfaces with the adhesive layer 82 substantially continuously covering surface 63 of label portion 60. The label portion 60 is separable from the envelope blank 10 without applying a release agent. The label portion 60 does not require the addition of any agents on the label portion 60 after its removal from the envelope blank 10, or the addition of any agents on the label portion 60 before its removal from the envelope blank 10, in order to be immediately reused upon removal from the envelope blank 10.

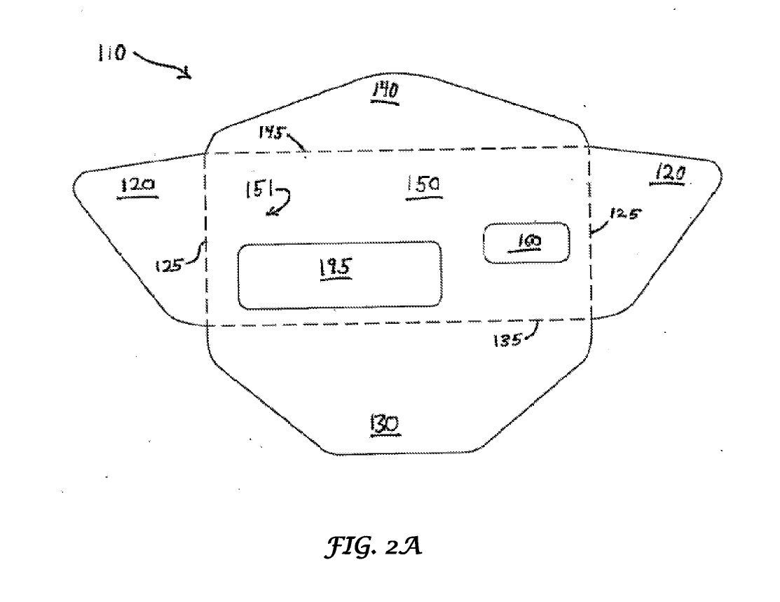

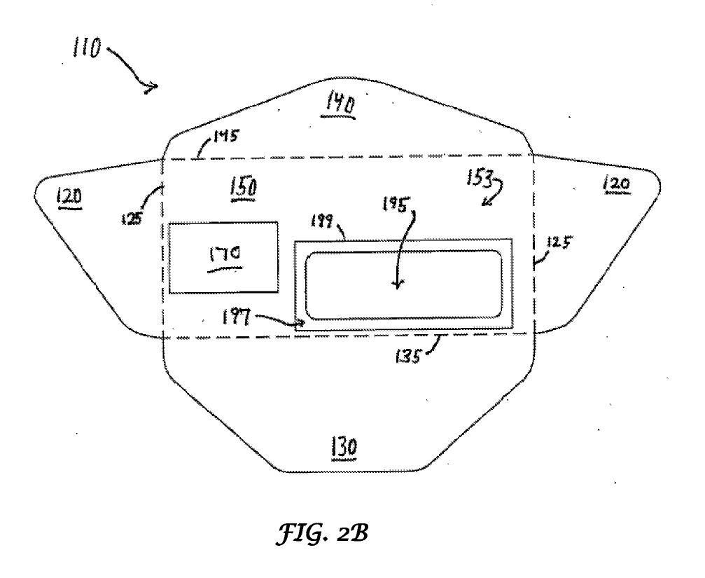

FIGS. 2A and 2B illustrate another embodiment of an unfolded envelope blank 110 similar to the unfolded envelope blank 10 illustrated in FIGS. 1A-1D. The unfolded envelope blank illustrated in FIGS. 2A and 2B may be folded and secured to form a look-in style envelope. FIG. 2A illustrates a front view of outwardly facing surfaces of the envelope blank, and FIG. 2B illustrates a rear view of inwardly facing surfaces of the envelope blank. As shown in FIGS. 2A and 2B, envelope blank 110 comprises a removable label portion 160 integrated in the face panel 150 of the envelope and secured by a liner 170. The envelope blank 110 also comprises sides flaps 120 extending from side edges 125, a bottom flap 130 extending from the bottom edge 135, and a closure panel 140 extending from the top edge 145.

The embodiment illustrated in FIGS. 2A and 2B is a look-in style envelope blank comprising a cut-out window 195 extending through the face panel 150 from the outwardly facing surface 151 to the inwardly facing surface 153 of the face panel 150. A substantially transparent window patch 199 is positioned over the window 195 and secured to the inwardly facing surface 153 of the face panel 150. The window patch 199 may be constructed from a substantially transparent solid polymer film and secured to the inwardly facing surface 153 of the face panel 150 in an overlapping region 197 with a window patch gum or other suitable adhesive.

FIGS. 3A-3D illustrate one embodiment of an envelope 15 formed from the envelope blank illustrated in FIGS. 1A-1D. FIG. 3A is a front view of the envelope 15 showing the closure panel 40 in an open position extending from the top edge 45. The removable label portion 60 is integrated in the face panel 50 of the envelope 15. FIG. 3B is a rear view of the envelope 15 showing the side flaps 20 and the bottom flap 30 folded together along side edges 25 and the bottom edge 35, respectively, to form rear panel 80. Label portion 60 and liner 70 are shown in dashed-line form to indicate that the label portion 60 and the liner 70 are not directly visible when viewing the rear panel 80 of the formed envelope 15.

The rear panel 80 comprises the side flaps 20 and the bottom flap 30 folded together along side edges 25 and the bottom edge 35, respectively, and secured together by seam gum or adhesive applied between the overlapping regions 85 of the flaps, as shown in FIG. 3C. In this manner, the overlapping regions 85 comprise side seams securing together the flaps comprising the rear panel 80. The closure panel 40 extending from the top edge 45 is configured to fold onto the rear panel 80 and secure thereto, thereby forming an enclosed space within the envelope. The closure panel 40 is shown in FIGS. 3B and 3C with an adhesive region 41. A seal flap gum or adhesive for securing the closure panel 40 to back panel 80 is applied to adhesive region 41. When the closure panel 40 is secured to the back panel 80, as shown in FIG. 3D, an enclosed space is formed within the envelope 15. When the envelope blank 10 is folded and secured into a formed envelope 15, the surfaces illustrated in FIG. 1A (the outwardly facing surfaces of the envelope) correspond to the surfaces illustrated in FIGS. 3A-3D.

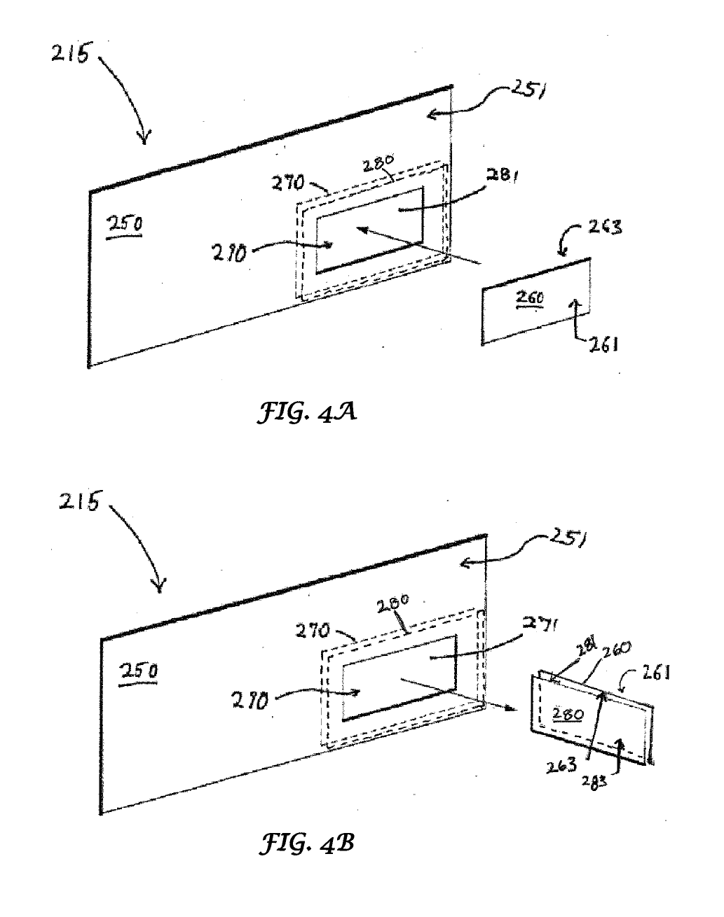

FIGS. 4A and 4B illustrate a partially exploded perspective view of a closed envelope 215. The envelope 215 comprises a face panel 250 having an outwardly facing surface 251. FIG. 4A shows a label portion 260 being positioned in the open portion 290, the label portion 260 is held in position by an adhesive layer 280 continuously covering the outwardly facing surface 271 of the liner 270. The adhesive layer 280 adheres to the inwardly facing surface 263 of the label portion 260 with the label portion is secured in the open portion 290. The adhesive layer 280 also secures the liner 270 to the inwardly facing surface of the face panel 250. FIB. 4B shows label portion 260 being separated and removed from the face panel 250 of the envelope 215, thereby revealing an open portion 290 through the face panel 250. The open portion 290 is covered by a liner 270 attached to the inwardly facing surface of the face panel 250 by an adhesive layer 280 and enclosed within the envelope 215. When the label portion 260 is removed from the envelope 215, as shown in FIG. 4B, the portion of the adhesive layer 280 adhering to the label portion 260 is also removed and the outwardly facing surface 271 of the liner 270 is visible within the enclosed envelope 215 through the open portion 290. As illustrated in FIG. 4B, the label portion 260 comprises a separate label that may be attached to another surface using the adhesive layer 280 now attached to it. The label portion 260 is separable from the envelope 215 without applying a release agent. The label portion 260 does not require the addition of any agents on the label portion 260 after its removal from the envelope 215, or the addition of any agents before its removal from the envelope 215, in order to be immediately reused upon removal from the envelope 215.

The adhesive layer 280 continuously covering the outwardly facing surface 271 of the liner 270 may comprise a removable adhesive configured to substantially transfer from the backing sheet of the liner to the paper comprising the envelope 215 and the label portion 260. In this manner, the integrated and removable label portion 260 may be separated and removed from the envelope 215 and attached to a separate surface. When applied to a separate surface, the outwardly facing surface 261 of the label portion 260 is visible. When the label portion 260 is separated and removed, the liner 270 remains attached to the inwardly facing surface of the face panel 250, thereby maintaining the integrity of the face panel 250 of the envelope 215. The outwardly facing surface 271 of the liner 270, which is exposed through the open portion 290 in the face panel 250 when the label portion 260 is removed, may be substantially free of the adhesive layer 280 because the adhesive layer 280 may be substantially transferred to the inwardly facing surface 263 of the label portion 260.

In various embodiments, the envelope and/or the label portion may comprise a paper material, such as, for example, vellum paper, Kraft paper, bond paper, tag paper, wove paper, or offset paper. In other embodiments, the envelope and/or the label portion may comprise a polymer based material, such as, for example, Tyvek®, vinyl, or translucent vinyl. The envelope blanks may be folded and secured into a formed envelope using a suitable gum or adhesive to secure the component flaps and panels together. For example, suitable side seam gums or adhesives may be used to secure component flaps together to form a back panel. Suitable seam gums and adhesives may include, for example, starch-based or dextrin-based adhesives. In embodiments comprising a closure panel configured to secure to a back panel using adhesive means, suitable seal flap gums and adhesives may be used, such as, for example, re-moistenable, pressure sensitive, or cohesive sealing type gums and adhesives. Suitable seal gums and adhesives may include, for example, latex, hotmelt, or transfer tape adhesive.

In embodiments comprising a cut-out window having a window patch, suitable transparent solid polymer films may include, for example, polypropylene film, cellophane film, styrene-butadiene co-polymer film, glassine, or vegetable-based films. Suitable window patch gums and adhesives may include, for example, starch-based or dextrin-based adhesives.

In various embodiments, the liner may comprise a backing sheet and a continuous film of removable adhesive applied to one side of the backing sheet. The adhesive may be removable with respect to the backing sheet but not removable with respect to the material comprising the envelope and label portion. The backing sheet may comprise, for example, a silicone paper or transparent polyester liner. The continuous film of adhesive may comprise a pressure-sensitive gum or adhesive, such as, for example, removable, repositionable, or permanent. In this manner, for example, the backing sheet and adhesive combination may be configured so that when the is applied to the inwardly facing surfaces of the face panel and the label portion positioned in the open portion formed by a die-cut through the face panel, the adhesive film will effectively transfer from the backing sheet to the paper comprising the face panel and the label portion. Therefore, the integrated and removable label portion may be separated and removed from the envelope and adhered to another surface.

The embodiments disclosed herein are also directed to processes for manufacturing envelopes. The processes may comprise feeding a continuous paper web to label-forming equipment. In the label-forming equipment, a plurality of label portions may be die-cut into the paper web. A plurality of adhesive liners may be applied to one side of the paper web in the label-forming equipment. The adhesive liners may cover the die-cut label portions and secure the die-cut label portions in the paper web. The paper web may be fed into separate die-cutting equipment. In the die-cutting equipment, a plurality of envelope blanks may be die-cut from the paper web. Each die-cut envelope blank may comprise at least one die-cut label portion secured in the envelope blank by the adhesive liner. The die-cut envelope blanks may be fed into envelope-forming equipment. In the envelope-forming equipment, adhesive may be applied to the envelope blanks The envelope blanks may be folded into formed envelopes. The formed envelopes may comprise at least one die-cut label portion secured in each envelope by the adhesive liner. The label portion may be integrated with the envelope and separable from the envelope to form a separate label.

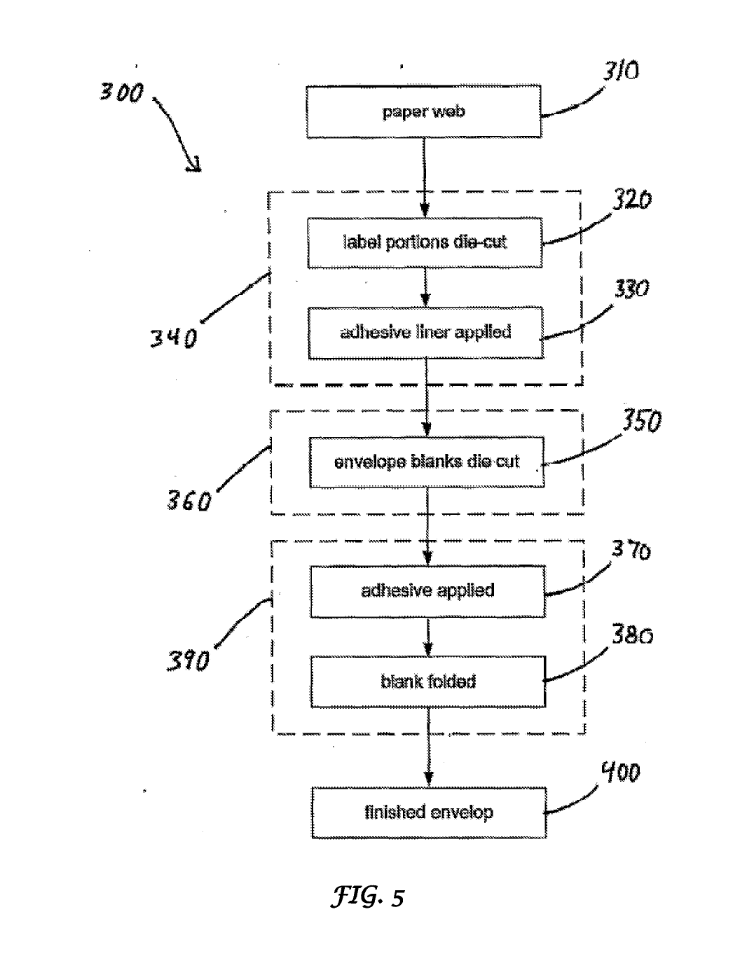

FIG. 5 is a flow diagram illustrating one embodiment of a process 300 for manufacturing envelopes having integrated and removable label portions. At step 310, a roll of paper web is placed in or otherwise fed to label-forming equipment 340. A plurality of integrated and removable label portions are formed in the paper web in the label-forming equipment 340. The paper web may be continuously fed through the label-forming equipment 340, in which the label portions are serially die-cut in the paper web at step 320. An adhesive liner is serially applied to the paper web over each die-cut label portion at step 330, thereby forming integrated and removable labels in the paper web. The paper may be re-rolled in the integrating equipment 340 after the removable label is formed. In this manner, the label-forming equipment may take the paper web from roll-to-sheet-to-roll, wherein the resulting roll comprises a paper web having a plurality of integrated and removable label portions formed therein.

The paper web comprising a plurality of integrated and removable label portions is fed to die-cutting equipment 360. In the die-cutting equipment 360, unfolded envelope blanks are die-cut from the paper web at step 350. Each die-cut envelope blank comprises at least one die-cut label portion secured in the envelope blank by an adhesive liner. The die-cutting equipment 360 may take the paper web from roll-to-sheet-to-blank, wherein the resulting unfolded envelope blanks comprise at least one die-cut label portion secured in the envelope blank by the adhesive liner.

The envelope blanks are continuously fed into envelope-forming equipment 390. In the envelope-forming equipment 390, seam gum or adhesive is applied to the overlapping portions of the side flaps and/or the bottom flap of the envelope blank at step 370. Seal gum or adhesive may also be applied to the closure panel at step 370. The envelope blanks are folded at step 380 so that the side flaps and the bottom flap come into contact to form the back panel of an envelope. The side flaps and bottom flap are secured together by side seams comprising the adhered overlapping portions of the side flaps and bottom flap, thereby forming the back panel of a formed envelope. The closure flap may be folded toward, but is not adhered to, the back panel at step 380. At step 400, formed envelopes emerge from the envelope-forming equipment.

In various embodiments, the label-forming equipment may comprise a Tamarack® machine (Tamarack Products Inc., Wauconda, Ill., USA), such as, for example, a Tamarack®P500, Versa-Web M500, or Specialist 300 machine. In various embodiments, the label-forming equipment may comprise, for example, an FME Micro Labeling System (Forms Manufacturers Equipment, Inc., Orlando, Fla., USA), a Hunkeler Sprinter Machine, a Hunkeler Vari-Web Machine, or a Hunkeler Mini-Web machine (Hunkeler AG, Wikon, Germany). In various embodiments, the die-cutting equipment may comprise, for example, an F.L. Smithe Hydraulic Press (manual or programmable) (F.L. Smithe Machine Company, Duncansville, Pa., USA) or a Sysco Die Cutting Machine (Sysco Machinery Corporation, Taiwan). In various embodiments, the envelope-forming equipment may comprise a W+D folding machine, such as, for example, a W+D 527 (Winkler+Diinnebier AG, Neuwied, Germany). In various embodiments, the envelope-forming equipment may comprise a F.L. Smithe folding machine.

In various embodiments, text, symbols, markings, or other indicia may be printed onto the envelope, including the removable label portion, at any stage of the manufacturing process. For example, indicia may be printed onto the paper web before it is fed to the label-forming equipment at step 310. Indicia may be printed onto the paper web in between label formation and the die-cutting of the envelope blank at step 350. Indicia may be printed onto the unfolded envelope blank in between the die-cutting of the envelope blank and formation of the envelope. Indicia may also be printed onto the formed envelope.

In addition, an optional cut-out window may be die-cut from the portion of the paper web that will form the face panel of the envelope. An optional transparent window patch may be applied to the inwardly facing surface of the face panel portion of the paper web or envelope blank to form a window patch through which contents within the envelope may be visible from outside the envelope when the closure flap is secured to the back panel. The cut-out window may be die-cut and the window patch may be applied using the envelope blank die-cutting equipment and/or the envelope-forming equipment. Alternatively, separate dedicated equipment may be used to form the optional cut-out window and optional window patch.

The disclosed envelopes may find utility in a number of applications, such as, for example, promotional advertising, document control, marketing, award notification, billing/invoicing, and the like. By way of example, a barcode or other identifying indicia may be printed on the label portions of the disclosed envelopes. The bar-coded labels may be separated from the envelopes and placed on documents or other items for identification and control purposes. Another exemplary application may involve removal of the label portion having first indicia printed thereon to reveal second indicia printed on the surface of the liner visible after the label portion is separated and removed from the envelope. In other embodiments, the backing sheet of the liner may be substantially transparent so that when the label portion is separated from the envelope, a cut-out window having a window patch is formed in the envelope.

In addition, the disclosed envelopes and manufacturing processes may be adaptable to a number of commercial applications. For example, generic envelope blanks or finished envelopes comprising one or more integrated and removable label portions may be manufactured without any indicia, thereby allowing for downstream print customization. In other embodiments, custom envelopes comprising specific markings or other indicia may be manufactured.

The claimed invention has been described with reference to certain exemplary, illustrative and non-limiting embodiments. For example, the envelope embodiments illustrated in the figures generally depict a commercial or business style envelope. However, it is understood that the figures are for illustrative purposes only, and the disclosed envelopes may comprise any style or configuration. Furthermore, the figures generally illustrate an integrated and removable label portion located in an open portion through the face panel of an envelope or envelope blank. However, it is understood that the label portion may be located in any panel of an envelope or envelope blank, including, for example, the closure panel and/or the back panel (i.e., in either or both side flaps and/or the bottom flap). Moreover, the figures generally illustrate one (1) label portion in the described envelopes and envelope blanks However, it is understood that the disclosed envelopes may comprise one, two or more label portions per envelope. Also, the figures generally illustrate closure flaps comprising adhesive means for securing the closure flap to the back panel to seal the envelope. However, it is understood that non-adhesive means for securing the envelope in a closed position may be used, such as, for example, metal clasps or string-and-button fasteners.

It is contemplated that any embodiment discussed in this specification can be implemented with respect to any method, kit, reagent, or composition of the invention, and vice versa. Furthermore, compositions of the invention can be used to achieve methods of the invention.

It will be understood that particular embodiments described herein are shown by way of illustration and not as limitations of the invention. The principal features of this invention can be employed in various embodiments without departing from the scope of the invention. Those skilled in the art will recognize, or be able to ascertain using no more than routine experimentation, numerous equivalents to the specific procedures described herein. Such equivalents are considered to be within the scope of this invention and are covered by the claims.

All publications and patent applications mentioned in the specification are indicative of the level of skill of those skilled in the art to which this invention pertains. All publications and patent applications are herein incorporated by reference to the same extent as if each individual publication or patent application was specifically and individually indicated to be incorporated by reference.

The use of the word “a” or “an” when used in conjunction with the term “comprising” in the claims and/or the specification may mean “one,” but it is also consistent with the meaning of “one or more,” “at least one,” and “one or more than one.” The use of the term “or” in the claims is used to mean “and/or” unless explicitly indicated to refer to alternatives only or the alternatives are mutually exclusive, although the disclosure supports a definition that refers to only alternatives and “and/or.” Throughout this application, the term “about” is used to indicate that a value includes the inherent variation of error for the device, the method being employed to determine the value, or the variation that exists among the study subjects.

As used in this specification and claim(s), the words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps.

The term “or combinations thereof” as used herein refers to all permutations and combinations of the listed items preceding the term. For example, “A, B, C, or combinations thereof” is intended to include at least one of: A, B, C, AB, AC, BC, or ABC, and if order is important in a particular context, also BA, CA, CB, CBA, BCA, ACB, BAC, or CAB. Continuing with this example, expressly included are combinations that contain repeats of one or more item or term, such as BB, AAA, AB, BBC, AAABCCCC, CBBAAA, CABABB, and so forth. The skilled artisan will understand that typically there is no limit on the number of items or terms in any combination, unless otherwise apparent from the context.

All of the compositions and/or methods disclosed and claimed herein can be made and executed without undue experimentation in light of the present disclosure. While the compositions and methods of this invention have been described in terms of preferred embodiments, it will be apparent to those of skill in the art that variations may be applied to the compositions and/or methods and in the steps or in the sequence of steps of the method described herein without departing from the concept, spirit and scope of the invention. All such similar substitutes and modifications apparent to those skilled in the art are deemed to be within the spirit, scope and concept of the invention as defined by the appended claims.

### REFERENCES

U.S. Pat. No. 5,002,220: Adhesive closure flap with protective liner and detachable tab.
U.S. Pat. No. 5,429,576: Apparatus for making reusable adhesive envelopes.
U.S. Pat. No. 7,213,844: Envelope with integrated tracking labels.

What is claimed is:

1. An envelope comprising:
a face panel, a back panel connected to the face panel, and a closure panel connected to the face panel and configured to be secured to the back panel, wherein each panel comprises an outwardly facing surface and an inwardly facing surface, wherein at least one of the face panel, the back panel, and the closure panel comprises an open portion having dimensions commensurate with a label portion, wherein the open portion extends through the panel from the outwardly facing surface to the inwardly facing surface;
a liner comprising a backing sheet and a continuous film of a pressure sensitive adhesive applied to a side of the backing sheet, the liner attached with the adhesive to the inwardly facing surface of the at least one panel comprising the open portion, wherein the adhesive of the liner covers the open portion on the inwardly facing surface of the panel; and
a label portion positioned within the open portion and removably secured to the liner with the adhesive, wherein the label portion is integrated with the panel comprising the open portion, wherein the label portion is separable from the envelope without tearing any portion of the envelope or any portion of the label portion, and wherein the label portion is separable from the envelope without applying a release agent.

2. The envelope of claim 1, wherein the continuous film of the pressure sensitive adhesive applied to the backing sheet comprises a removable adhesive that substantially transfers from the backing sheet to the label portion so that the label portion comprises a substantially continuous film of pressure sensitive adhesive when the label portion is separated from the envelope, thereby forming a separate adhesive label.

3. The envelope of claim 1, wherein the face panel, the back panel, the closure panel, and the label portion all comprise paper die-cut from a common paper web.

4. The envelope of claim 1, further comprising a window extending through the face panel.

5. The envelope of claim 4, further comprising a substantially transparent window patch adhered to the inwardly facing surface of the face panel, the window patch positioned on the inwardly facing surface of the face panel covering the window.

6. The envelope of claim 1, wherein the label portion comprises indicia printed into an outwardly facing surface of the label portion.

7. A process for manufacturing an envelope comprising:
feeding a continuous paper web to label-forming equipment;
die-cutting a plurality of label portions in the paper web;
applying a plurality of adhesive liners to one side of the paper web, wherein the adhesive liners cover the die-cut label portions and secure the die-cut label portions in the paper web;
feeding the paper web to die-cutting equipment;
die-cutting a plurality of envelope blanks from the paper web, wherein each die-cut envelope blank comprises at least one die-cut label portion secured in the envelope blank by the adhesive liner;
feeding the die-cut envelope blanks to an envelope-forming equipment;
applying an adhesive to the envelope blanks; and
folding the envelope blanks into formed envelopes comprising at least one die-cut label portion secured in each envelope by the adhesive liner, wherein the label portion is integrated with the envelope and separable from the envelope to form a separate adhesive label, wherein the label portion is separable from the envelope without applying a release agent.

8. The process of claim 7, wherein the label-forming equipment comprises a Tamarack® machine.

9. The process of claim 7, wherein the envelope-forming equipment comprises a W+D folding machine or a F.L. Smithe folding machine.

10. The process of claim 7, further comprising die-cutting a window through a face panel of the envelope blank.

11. The process of claim 10, further comprising applying a transparent window patch over the die-cut window.

12. The process of claim 7, further comprising applying printing indicia into an outwardly facing surface of the adhesive label.

13. A system for manufacturing an envelope comprising:
a Tamarack® machine or a suitable label-forming equipment, wherein the label-forming equipment die-cuts a plurality of label portions on a fed continuous paper web followed by application of a plurality of adhesive liners to one side of the paper web covering the die-cut label portions and secure the die-cut label portions in the paper web;
a die-cutting equipment for die-cutting a plurality of envelope blanks from the paper web, wherein each die-cut envelope blank comprises at least one die-cut label portion secured in the envelope blank by the adhesive liner;
an equipment for die-cutting a window through a face panel of the envelope blank;
an equipment for applying a transparent window patch over the die-cut window;
a W+D folding machine, a F.L. Smithe folding machine or a similar envelope-forming equipment, wherein the equipment applies an adhesive to the envelope blanks and folds the envelope blanks into formed envelopes comprising at least one die-cut label portion secured in each envelope by the adhesive liner, wherein the label portion is integrated with the envelope and separable from the envelope to form a separate adhesive label, wherein the label portion is separable from the envelope without applying a release agent; and
a printing equipment for printing optional indicia into an outwardly facing surface of the adhesive label.
